(19) United States
(12) Patent Application Publication
(10) Pub. No.: US 2026/0033468 A1
(43) Pub. Date: Feb. 5, 2026

(54) ON DEMAND-DELAYED BUOY RELEASE

(71) Applicant: Russ Mullins, Ferndale, WA (US)

(72) Inventor: Russ Mullins, Ferndale, WA (US)

(21) Appl. No.: 19/062,365

(22) Filed: Feb. 25, 2025

Related U.S. Application Data
(63) Continuation-in-part of application No. 18/791,713, filed on Aug. 1, 2024.

(51) Int. Cl. A01K 69/08; B63B 21/00; B63B 22/08

(52) U.S. Cl. CPC A01K 69/08; B63B 22/08; B63B 2021/007

(57) ABSTRACT

An apparatus and technique for underwater storage and deployment of a fishing line and buoy includes a cylinder coupled to a fishing apparatus. A buoy is attached to a buoy line coupled to the fishing apparatus and the buoy line and buoy are stowed within the cylinder in a first position. A holding mechanism holds a top perimeter of the cylinder closed until intentionally released. Upon release of the holding mechanism, the buoy and buoy line escape the cylinder. The buoy then pulls the buoy line to the surface where the fishing apparatus can be recovered by the fisher.

### PRIORITY CLAIM AND CROSS-REFERENCE TO RELATED APPLICATION

This application is a continuation-in-part of U.S. patent application Ser. No. 18/791,713, filed on Aug. 1, 2024, which is hereby incorporated by reference in its entirety.

### BACKGROUND

This disclosure relates to devices for underwater storage and deployment of buoys and lines and particularly to devices for the underwater deployment of buoys and lines for use with crab, lobster and other shellfish and fish traps. The disclosure eliminates traditional vertical buoy lines in the water column in order to eliminate risk of whale and other sea life entanglement and mortality.

Fish and shellfish traps and the like lie on the ocean floor and their recovery is effected by means of a vertical line connected to a surface float or buoy. Often the buoy line is required to pull loads exceeding 5000 lbs. because shellfish gear can become buried in sand or hung up on other obstacles that require extreme force in order to dislodge and recover the trap. The surface float is almost essential for the location and recovery of the trap. However, the existence of vertical buoy lines in the water column and the associated exposed surface buoys has led to widespread large whale and sea turtle entanglement issues that have unacceptably high mortality rates. The widespread use of vertical buoy lines and the associated harm to protected species has led to the premature closure of multi-million-dollar fish and shellfish fisheries.

To address this problem several devices have been invented that allow a buoy attached to a fish trap to be released after some time interval, or by radio or sonar control. Some examples of these devices are found in the following U.S. Patents. U.S. Pat. No. 3,426,472 to Richard teaches an alloy link that is designed to corrode in salt water over a certain time period. The buoy is suspended just above the trap with the link restraining the buoy to keep it near the trap. Once the link corrodes through, the buoy is free to rise to the surface where it can be recovered. Different alloys produce different break times so any delay up to 14 days can be selected.

U.S. Pat. No. 3,724,120 to Richard teaches an improved device for releasing buoys that uses an anode and cathode. The cathode can be reused, while the anode is destroyed.

U.S. Pat. No. 4,126,415 to Blockburger teaches an underwater release mechanism for a shackle including a shaft releasably journaled in a casing and held in position by a frangible link to be spring biased to release a shackle hook upon remote actuation by a radio signal, causing the link to fracture whereby the shackle is released, and the release mechanism floats to the surface. A rope canister can be attached to the casing with one end of the rope tied to the shackle whereby after release the canister end of the rope is tied to the float to mark the spot of the shackle.

U.S. Pat. No. 4,262,379 to Jankiewicz teaches a marker buoy attached to an object such as a lobster or crab trap by a latch and released by a trigger struck by a falling weight. A sealed buoy compartment contains a first permanent magnet holding the weight in upper position by a supportive pole relationship to the poles of a second permanent magnet on the weight and releasing the weight when the first magnet is pivoted to a relative position of poles not sufficiently supportive of the weight. The first magnet is pivoted by an electric motor controlled by an electric clock (or an optional radio signal). Setting of the clock and other operations are accomplished without disturbing compartment seals by an external hand-held magnet operating on internal magnetic reed switches. A line tethers the buoy to the object when the latch is released.

U.S. Pat. No. 6,261,142 to Fiotakis teaches a buoy that has a release mechanism that permits the buoy to be automatically released to ascend to the surface. The release unit may be operated by a remotely transmitted signal or initiated directly by a timer or a controller where specific circumstances dictate.

U.S. Pat. No. 7,534,152 to Lloyd et al. teaches an underwater buoy release system having a moment arm release system. The moment arm release system has a magnetically attractive arm structure connected to a buoy. The buoy release system further includes an electromechanical device that moves the magnetically attractive elements toward, and away from, the magnetically attractive arm structure. The buoy release system further includes a signal reception device, wherein the signal reception device that receives a remote signal from a transmission device.

Note that the latter group of patents employ line enclosures or line spools that require specialized buoy lines or ropes that are not typically used in shellfish and fish pot fisheries. Their incorporation into existing fishing operations is not practical due to design limitations. The current disclosure solves this problem by allowing for the use of traditional and/or industry standard buoy lines and buoys.

### SUMMARY

This Summary is provided to introduce a selection of concepts in a simplified form that are further described below in the Detailed Description. This Summary is not intended to identify key features or essential features of the claimed subject matter, nor is it intended to be used as an aid in isolation to determine the scope of any claimed subject matter.

The instant disclosure overcomes the difficulties described above while eliminating the risk of whale entanglement. In brief and at a high level this disclosure describes, among other things, improved techniques and apparatus for setting and recovering shellfish traps and the like. More specifically, the disclosure relates to devices, methods, and techniques for storing the buoy line and buoy at the water's bottom without the need for a persistent surface float or a buoy line in the water column. A retention device including a cylinder with top and bottom perimeters is disclosed. The bottom perimeter can be attached to a fishing apparatus. A buoy is attached to a buoy line coupled to the fishing apparatus and the buoy line and buoy are stowed within the cylinder in a first position. The buoy line is arranged in a coil within the cylinder for a smooth and tangle-free release. One of various holding devices holds they buoy in the cylinder until intentionally released. Upon release, the buoy and buoy line escape the cylinder. The buoy rises to the surface with the buoy line attached. Accordingly, the buoy line is not in the water column (as a potential hazard to sea life) until the fishing apparatus is ready to be retrieved.

One embodiment of the retention device can comprise a retrofit to be added to a traditional trap (lobster, crab, fish, etc.). The retention device can be secured on the top of the traditional trap, for example. Another embodiment comprises a trap with a retention device built into the trap. The retention device can be disposed at one portion of the trap, away from another portion intended to hold lobster, crab, fish, etc. A divider may be disposed between the two portions. In a further embodiment, a specialized line and buoy retention container can be attached to the end(s) of a string of one or more submerged traps known as “groundlines” or “trawls.” The line retention container can have polygonal or circular line storage compartments based on specific applications. Various embodiments can make use of a galvanic or mechanical timer release or an on-demand release that is triggered by a signal (e.g., an electronic or acoustic signal) remotely transmitted from the surface, or other automatic or remote release technique.

Unlike prior art designs, orderly storage of the buoy line and buoy in a form which can be applied to existing commercial fisheries is achieved. Buoy line and buoys can be managed by the retention device in such a way as to minimize the risk of line tangles or snarls that prevent the buoy from reaching the surface, resulting in gear loss and ghost gear ecological damage. For example, the instant disclosure provides keeping the buoy and associated lines in a compact package as part of the retention device or in the line retention container. Uniquely, a buoy can be nested and securely held in place at the center of a coil of line. This keeps the line coil in a neat, tangle-free, form until the buoy is released to the surface.

Additionally, the current disclosure provides operationally viable repacking and redeployment capabilities, as well as easy adjustment of the line capacity as required for tangle-free operation in varied depths. Frequently, fishers are required to attach buoy release systems to the end of strings of traps connected by a common line and spaced up to ¼ mile apart. Slack in the common line between the buoy release system and the nearest trap often drifts with the current near the bottom. As the common line drifts over the buoy release system, it can catch on any buoys or other apparatus floating above, or protruding from the buoy release system, causing buoy fouling and probable system failure. Accordingly, slack in the common line is undesirable. The current disclosure uniquely solves this problem by completely enclosing the buoy and buoy line within the retention device, therefore, system failures are prevented.

The instant disclosure employs traditional commercial fishing buoy line and buoys which ensures the most durable and practical buoy lines and buoys can be used. Fishers are not required to replace expensive buoy lines or use buoy lines with inferior durability or mechanical functionality.

The retention device of the instant disclosure consists of an adjustable apparatus that integrates or secures the buoy line and buoy to a fish or shellfish trap or within a specialized line retention container, or sled, until released. In some embodiments, a galvanic timed release (GTR) coupling or mechanically-triggered release releases the buoy to the sea surface. The GTR coupling timer is constructed of a highly corrosive anode link which breaks after a predetermined period of immersion in seawater. In other embodiments, mechanical releases can be activated by timers or the receipt of a remotely triggered signal, such as an electronic or acoustic signal, or the like.

Upon release, the unrestrained buoy and buoy line rises to the surface so that the trap may be recovered. The present disclosure achieves the critical requirement that the buoy line and buoy be constrained within the apparatus in such a manner that it cannot become fouled, tangled or otherwise compromised by current, debris or other components of the fishing gear, to the point where the buoy and line is not capable of reaching the surface. A smooth and controlled release of the buoy line is maintained to avoid fouling. Thus, it is important that the buoy and, perhaps more importantly, the line associated with it, are packaged in a way to prevent fouling of those lines. Otherwise, even if the buoy were released, fouled lines would not let it reach the surface, resulting in the possible loss of the entire gear set and potential whale entanglement.

The current technique can use a cylindrical line storage compartment (e.g., mesh or wire cylinder) instead of a rectangular line storage compartment. This component uniquely accommodates traditional fishing rope that by design naturally coils in a circular manner. Conversely, the line naturally uncoils upon deployment to the surface in a more organized manner that is far less likely to become fouled or tangled. In addition, it is much quicker and easier to coil typical fishing line or rope into a cylinder than it is a cube. However, the line retention container, within which the cylinder can be affixed, can have a cube shape or other polygonal shape, since it surrounds the mesh cylinder.

### BRIEF DESCRIPTION OF THE DRAWINGS

The detailed description is set forth with reference to the accompanying figures.

FIG. 1A is a perspective view of an example retention device, including a cylinder and coupling support, according to an implementation.

FIG. 1B is a perspective view of an example retention device, including a cylinder, according to another implementation.

FIG. 1C is a perspective view of an example retention device, including a cylinder, according to another implementation.

FIG. 2 is a detail view of a drawstring attached to mesh netting, with the drawstring in the first position, according to an implementation.

FIG. 3 is a detail view of a drawstring attached to mesh netting, with the drawstring in the second position, according to an implementation.

FIG. 4A is a view of a buoy line and buoy stowed within the retention device, with the drawstring in the first position, according to an implementation.

FIG. 4B is a view of a buoy line and buoy stowed within the retention device, with the drawstring in the first position, according to another implementation.

FIG. 5 is a view of a buoy line and buoy being released from the retention device, with the drawstring in the second position, according to an implementation.

FIG. 6 is a view of the retention device coupled to a fish trap or shellfish trap as an add-on retrofit, according to an implementation.

FIG. 7A is a perspective view of a cylinder within an example line retention container, according to an implementation.

FIG. 7B is a perspective view of the retention device coupled within a line retention container, according to an implementation.

FIG. 7C is a perspective view of the retention device coupled within a line retention container, according to another implementation.

FIG. 7D is a perspective view of the retention device coupled within a line retention container, according to another implementation.

FIG. 7E is a side view showing the retention device coupled within the line retention container in a first position, according to an implementation.

FIG. 7F is a side view showing the retention device coupled within the line retention container in a second position, according to an implementation.

FIG. 7G is a side view of the retention device coupled within a line retention container, according to another implementation.

FIG. 8 shows a retention device and line retention container coupled to a plurality of fish or shellfish traps, according to an implementation.

FIG. 9 is a perspective view of a retention device integrated with a shellfish trap, according to an implementation.

FIG. 10 is a flow diagram illustrating an example method, according to various implementations.

### DETAILED DESCRIPTION

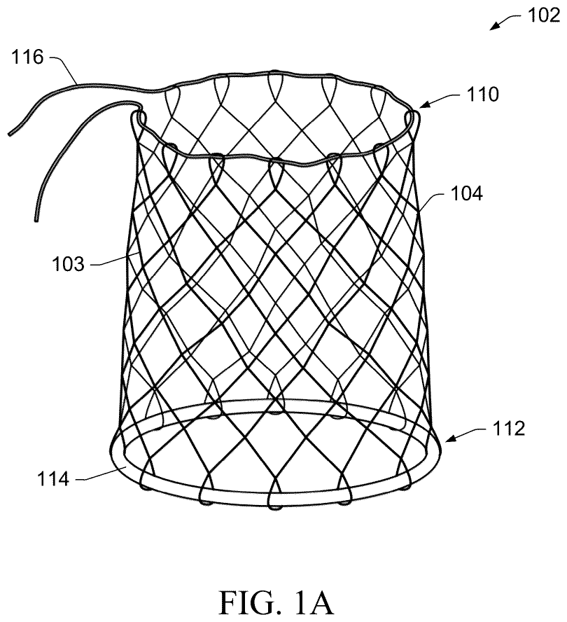

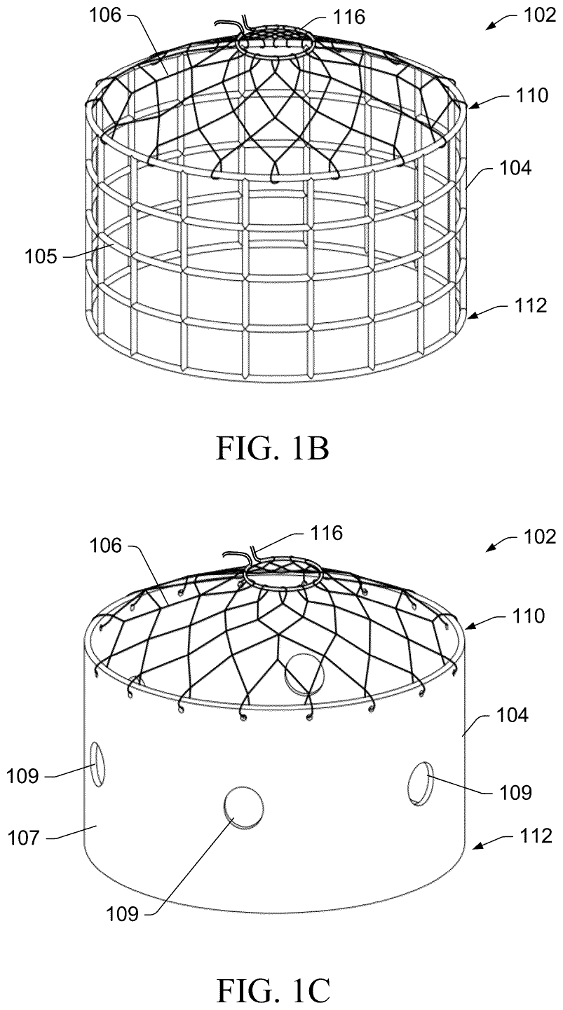

Representative techniques, devices, and systems disclosed herein provide for restraining a buoy line and buoy of a shellfish trap, or the like, beneath the surface of the water for a predetermined period of time using a retention device, and then deploying the buoy line and buoy in such a manner that the trap can be dependably recovered. Referring to FIGS. 1-9, a delayed buoy release system 100 is disclosed. The system 100 comprises a retention device 102 and a trigger device 602, and can also include a line retention container 702 and/or a fish trap 604 or shellfish trap 902. In various embodiments, the retention device 102 can be deployed to an existing fish or shellfish trap as an add-on or retrofit or incorporated within a fish or shellfish trap, or the like, to form an embodiment of the system 100. In other embodiments, the retention device 102 with the line retention container 702 comprises a system 100. The system 100 can also be coupled to one or more (additional) fish or shellfish traps 804, or the like, to form a combined trap system 802.

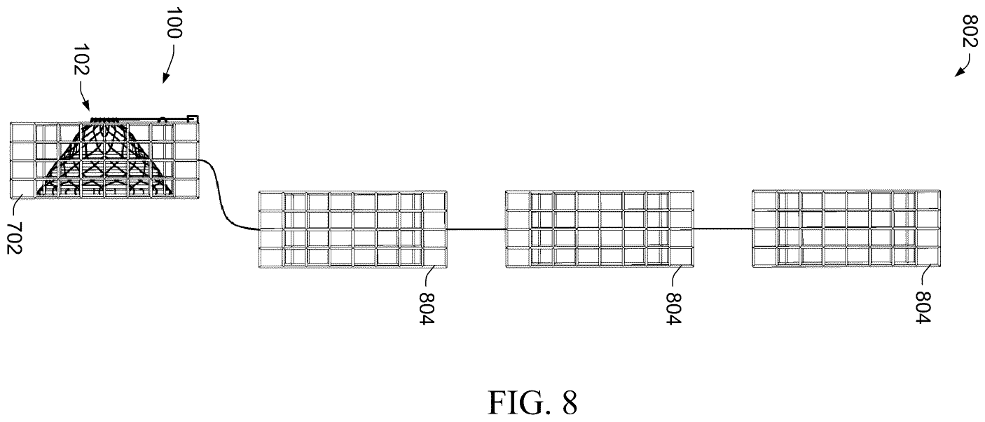

The retention device 102 can be added (e.g., retrofit) to all standard commercial-style crab and lobster traps, can be integrated into a commercial-style crab and lobster traps to form an integrated system 100, or can be installed into a line retention container 702 (or sled) that can optionally be attached to a string of one or more traps 802. (See, e.g., FIG. 8.) Other applications are also contemplated and are within the scope of this disclosure.

Referring particularly to FIGS. 1-5, the primary component of the retention device 102 comprises a cylinder 104, which is arranged to hold the buoy line 402 in a coil and the buoy 404, and which can be constructed from various materials as desired. For instance, in one example, a cylinder 104 comprises a mesh net cylinder. In another example, a cylinder 104 comprises a wire mesh cylinder. In further examples, a cylinder 104 comprises a solid-sided cylinder with or without holes in the side surfaces of the cylinder. Other cylinders 104 can include polygons with a generally cylindrical form, and the like. The use of the cylindrical form provides the advantage of storing the buoy line 402 in a coil so that the buoy line 402 is released in a smooth and tangle-free manner.

In an example, as shown at FIG. 1A, a custom-sized piece of high-density polyethylene trawl net material 103, or the like, is cut and formed into a cylinder 104. The size and dimensions of the cylinder 104 are based on the size of the trap or specialized enclosure (e.g., line retention container 702). For example, the dimensions and pitch of the netting 103 can be sized based on the circumference or perimeter of the trap receiving the retrofit or that of the specialized container and the amount of buoy line intended. A sheet of netting 103 can be formed into a mesh cylinder 104 by securely joining opposite edges with twine or metal rings, or the like. Accordingly, a mesh cylinder 104 has a generally elliptical top perimeter 110 and a generally elliptical bottom perimeter 112.

As shown at FIG. 1A, a coupling support 114 can be added to the bottom perimeter 112 to provide a robust support structure for coupling the mesh cylinder 104 to another structure, such as a fish trap or a line retention container 702. In some cases, the coupling support 114 can comprise a rigid or semi-rigid hoop, or like structure, with an elliptical, polygonal, or irregular perimeter. In one case, a hoop coupling support 114 can be constructed from a length of flexible plastic pipe or tubing equal to the circumference or bottom perimeter 112 of the mesh cylinder 104. The tubing of the coupling support 114 can be threaded through the webbing of the netting 103 of the bottom perimeter 112 of the mesh cylinder 104. The ends of the tubing can then be connected to form a circular hoop.

A drawstring 116 can be threaded through the webbing of the netting 103 of the top perimeter 110 of the mesh cylinder 104 to close the top perimeter 110 when in the closed position. For example, the drawstring 116 can be constructed of a length of ⅛″ twine (for example—wire or other sizes of strings can also be used). To make sure that the drawstring 116 has sufficient length, the length can be at least 25% greater than the circumference of the coupling support 114 (e.g., hoop).

In another example, as shown at FIG. 1B, a custom-sized piece of wire mesh material 105, or the like, is formed into a cylinder 104. The size and dimensions of the cylinder 104 are based on the size of the trap or specialized enclosure (e.g., line retention container 702). For example, the dimensions and pitch of the mesh 105 can be sized based on the circumference or perimeter of the trap receiving the retrofit or that of the specialized container and the amount of buoy line intended. A sheet of wire mesh 105 can be formed into a cylinder 104 by securely joining opposite edges with metal rings, by welding or soldering, or the like. The gauge of wire mesh 105 selected can vary and can be based on the strength and durability desired. A wire mesh cylinder 104 also has a generally elliptical top perimeter 110 and a generally elliptical bottom perimeter 112.

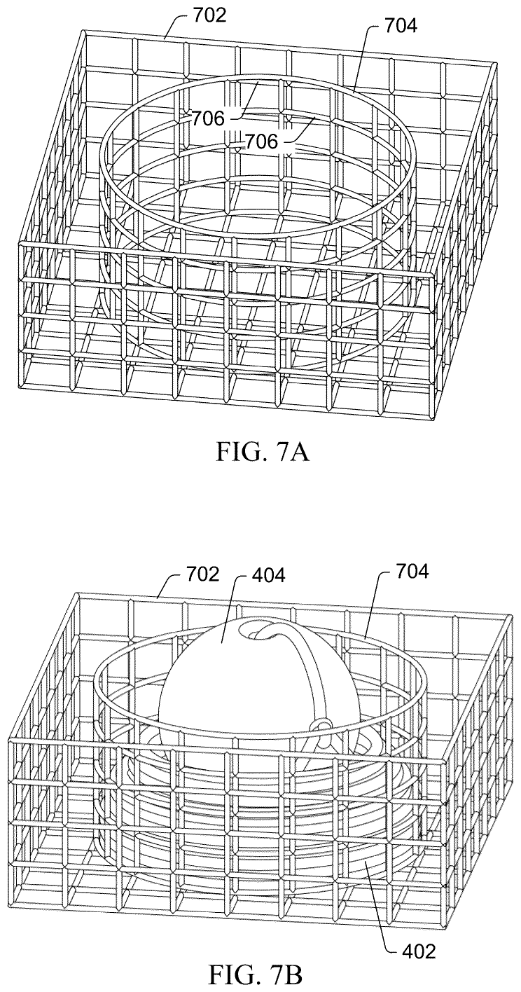

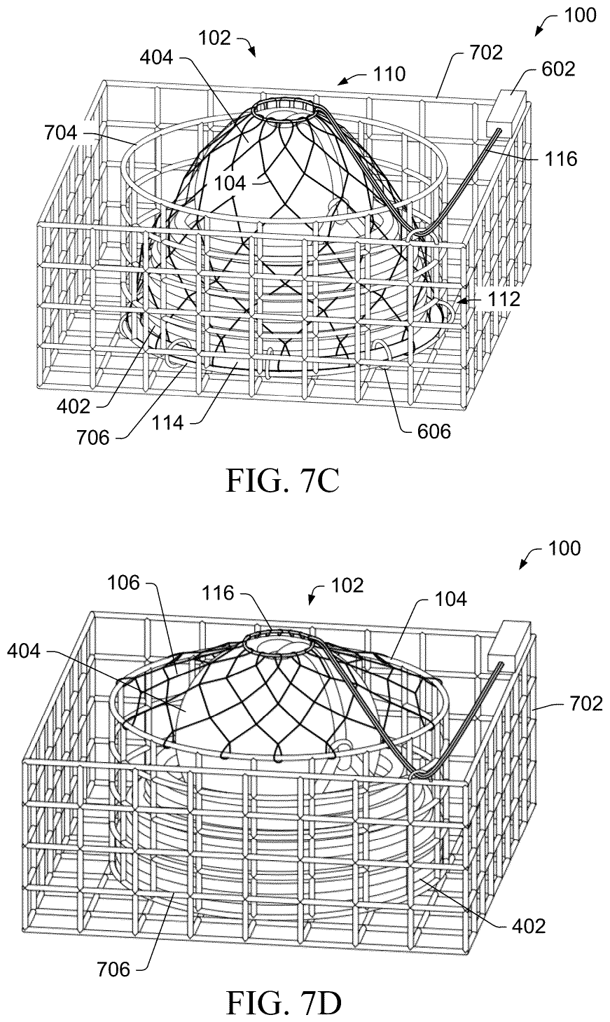

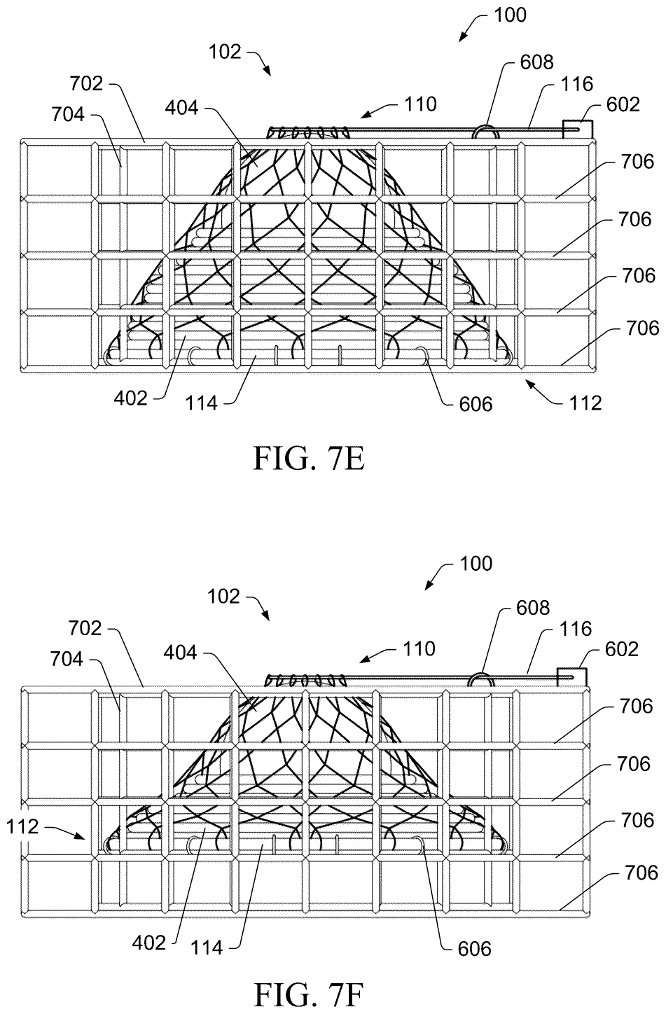

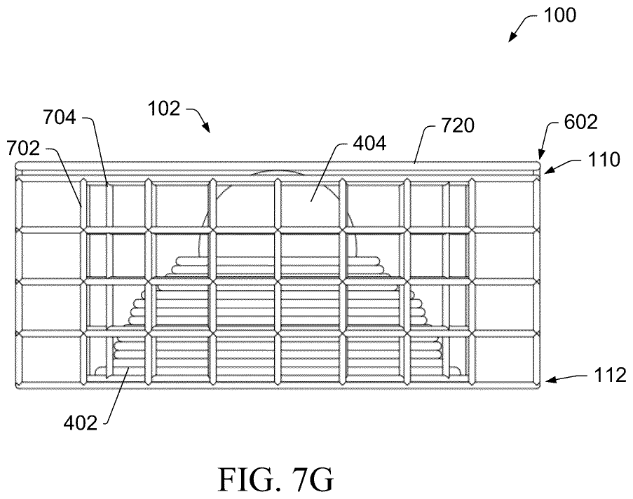

A net top 106 can be secured to the top perimeter 110 of the cylinder 104 to hold the buoy line 402 and buoy 404 in the cylinder 104 until intentionally deployed. A drawstring 116 can be threaded through the webbing of the net top 106 to close the top perimeter 110 when in the closed position. For example, the drawstring 116 can be constructed of a length of ⅛″ twine (for example—wire or other sizes of strings can also be used). To make sure that the drawstring 116 has sufficient length, the length can be at least 25% greater than the circumference of the top perimeter 110. Alternately, a hinged arm, a trap door, or another remotely releasable barrier can be movably or removably coupled to the top perimeter 110 of the cylinder 104 to hold or block, and to deploy the buoy line 402 and buoy 404 (see FIG. 7G).

In another example, as shown at FIG. 1C, a custom-sized sheet of material 107, comprising a metal, a composite, a polymer, or the like, is formed into a cylinder 104. The size and dimensions of the cylinder 104 are based on the size of the trap or specialized enclosure (e.g., line retention container 702). For example, the dimensions of the sheet of material 107 can be sized based on the circumference or perimeter of the trap receiving the retrofit or that of the specialized container and the amount of buoy line intended. A sheet of material 107 can be formed into a cylinder 104 by securely joining opposite edges by welding or soldering, or the like. Alternately, the cylinder 104 can be formed as a cylinder initially, e.g., by extrusion, three-dimensional printing, etc. The material 107 can be selected based on the strength and durability desired, as well as its capability to sustain continual submersion in sea water. The cylinder 104 also has a generally elliptical top perimeter 110 and a generally elliptical bottom perimeter 112.

In some examples, as shown at FIG. 1C, the cylinder 104 can include (as an option) a plurality of holes 109 in the cylinder walls. (Note that holes 109 in the cylinder 104 are not required.) The plurality of holes 109 can be arranged to assist water filling the cylinder 104, without creating an undesirable vacuum, when the cylinder 104 is submerged. The holes 109 can be of any size and quantity desired, to achieve the performance desired. Also, the holes 109 can be arranged in one or more patterns, or can be disposed randomly along the surface of the cylinder 104. Finally, the holes 109 can have an elliptical shape, a polygonal shape, a random shape, or a combination of shapes throughout the cylinder 104.

A net top 106 can be secured to the top perimeter 110 of the cylinder 104 to hold the buoy line 402 and buoy 404 in the cylinder 104 until intentionally deployed. A drawstring 116 can be threaded through the webbing of the net top 106 to close the top perimeter 110 when in the closed position. For example, the drawstring 116 can be constructed of a length of ⅛″ twine (for example—wire or other sizes of strings can also be used). To make sure that the drawstring 116 has sufficient length, the length can be at least 25% greater than the circumference of the top perimeter 110. Alternately, a hinged arm, a trap door, or another remotely releasable barrier can be movably or removably coupled to the top perimeter 110 of the cylinder 104 to hold or block, and to deploy the buoy line 402 and buoy 404.

It will be understood that other types of cylinders can be employed as the cylinder 104 and remain within the scope of the disclosure. Further, cylinders 104 can be formed from a series of planar sections and still have an overall cylindrical shape. The cylindrical shape of the cylinder 104 is advantageous to promote the buoy line 402 to attain the desired coil within the cylinder 104 during storage, and to release in a smooth and tangle-free manner upon deployment. Similar shaped cylinders 104 that cause the buoy line 402 to perform in like manner are also included in the disclosure.

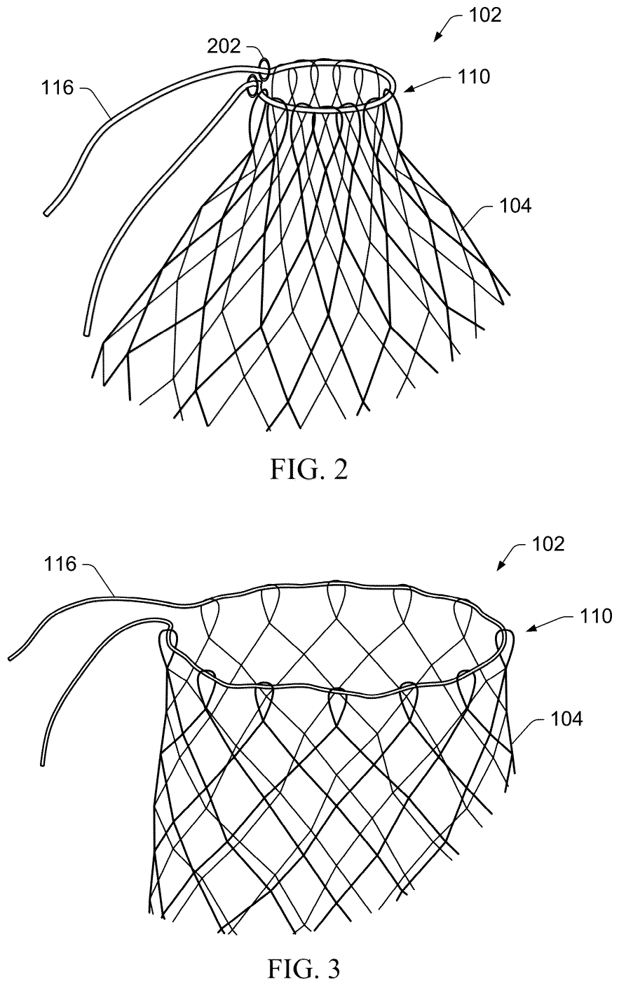

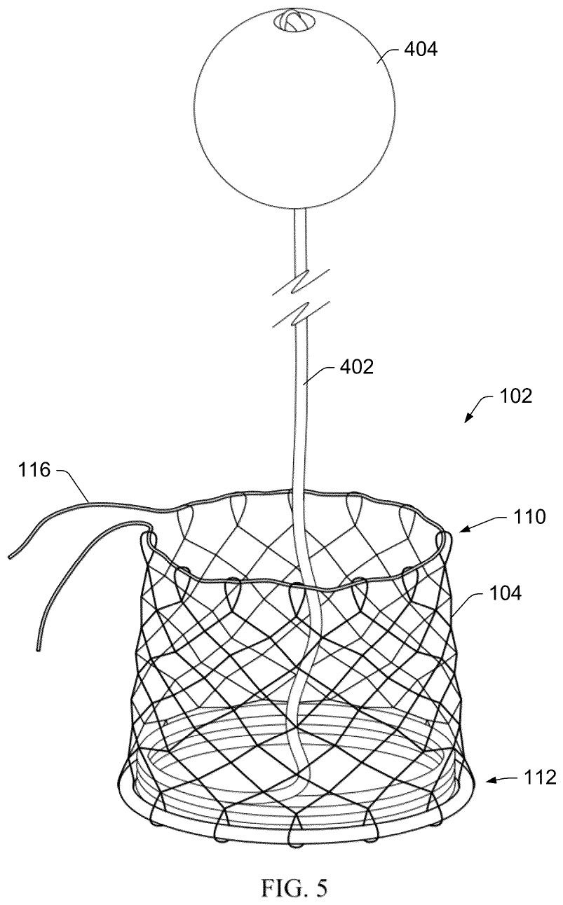

FIGS. 2-5 represent the mesh net cylinder 104 as shown at FIG. 1A and the net top 106 as shown at FIGS. 1B and 1C. It will be understood that other types of tops or hold-and-release devices and systems can be employed to provide the same or similar functionality. As shown at FIG. 2, when pulled taut, the drawstring 116 pulls the top perimeter 110 of the mesh net cylinder 104 or the top opening of the net top 106 together, closing the top perimeter 110 and creating a pucker in the top perimeter 110 of the mesh cylinder 104 or the top opening of the net top 106. This is the closed position. Optionally for convenience, a ring 202 (or the like) can be added to the pucker-edge of the mesh of the top perimeter 110 top opening of the net top 106 to allow the drawstring 116 to move without binding or creating excessive friction wear on the net mesh. As shown at FIG. 3, when the drawstring 116 is allowed to slacken (such as when released by a trigger mechanism 602, for example), the top perimeter 110 top opening of the net top 106 opens to allow contents of the cylinder 104 to escape (See also FIG. 5.)

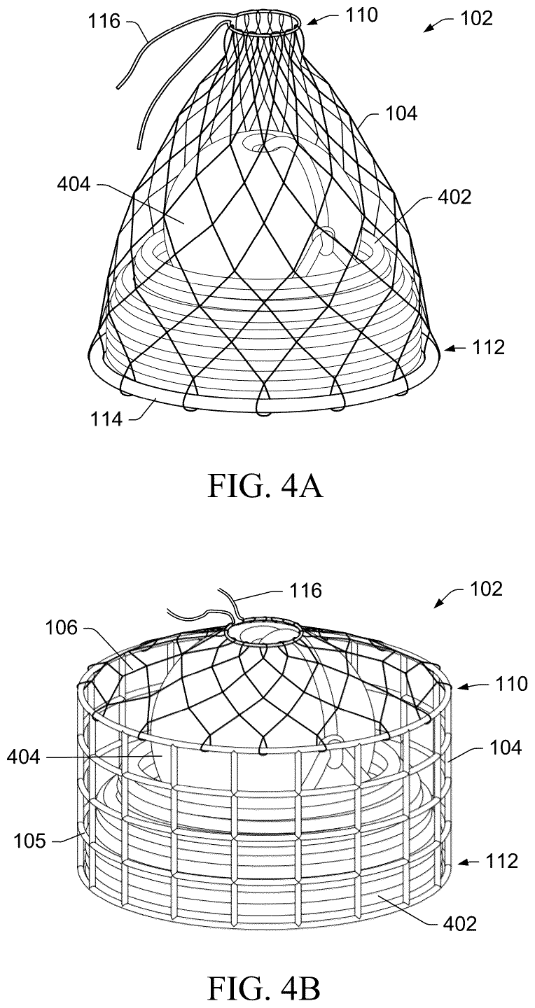

Referring to FIGS. 4A and 4B, two embodiments of cylinders 104 are shown in the closed position. Note that the following description also applies to other cylinders 104, including the example described with reference to FIG. 1C. A buoy line 402 having a proximal end and a distal end is added into the cylinder 104 and coiled within the cylinder 104. The buoy line may be coupled to a fish trap or a line retention container 702, or the like, at the proximal end. A buoy 404 can be coupled to the distal end of the buoy line 402.

The buoy line 402 is stowed within the cylinder 104 in the closed position. The buoy line 402 can be coiled within the cylinder 104 for ease of deployment. The buoy 404 can be nested in the coils of the buoy line 402 while stowed within the cylinder 104 of the retention device 102. The puckered top perimeter 110 or net top 106 snugly holds the buoy 404 and the buoy line 402 in the stowed position within the retention device 102.

As shown at FIG. 5, the buoy line 402 is free to extend in the open position. The buoy 404 attached to the distal end of the buoy line 402 is also free to rise to the water's surface. The buoy 404 is stowed within the cylinder 104 in the closed position (FIGS. 4A and 4B) and is released from the cylinder 104 in the open position (FIG. 5). When the buoy 404 is released from the cylinder 104, the buoy line 402 is pulled out of the cylinder 104 by the buoy 404. In various embodiments, the buoy 404 can comprise a properly sized hard plastic buoy 404 that is rated for extreme depths. For instance, conventional foam buoys can compress at depth, losing flotation and leading to permanent loss of the gear.

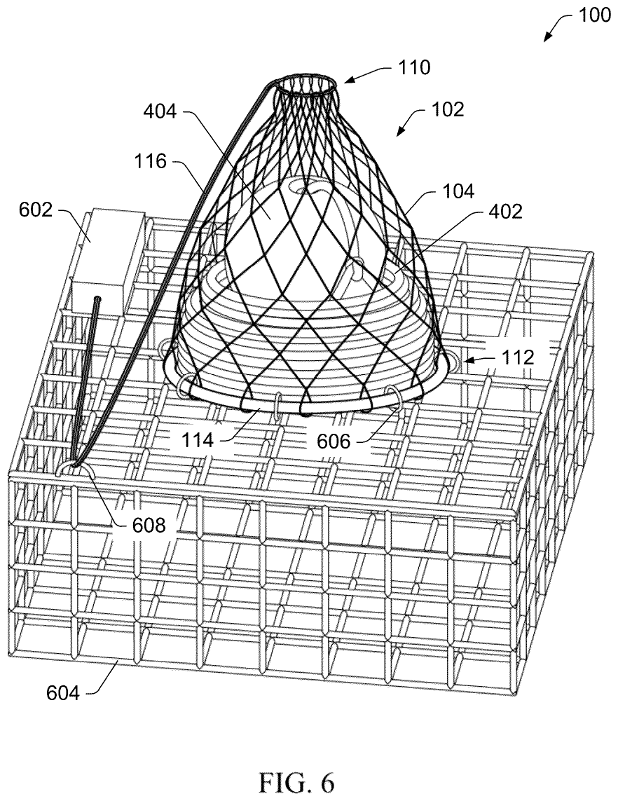

Referring to FIG. 6, in some cases the retention device 102 can be triggered (to automatically release the buoy 404 and buoy line 402) using one of various trigger mechanisms 602. The trigger mechanism 602 is coupled to the drawstring 116 and configured to hold the drawstring 116 taut and in the closed position until triggered. The trigger mechanism 602 is configured to activate the open position when triggered. In other words, when triggered, the trigger mechanism 602 causes the drawstring 116 to slacken, resulting in the release of the buoy 404 and the buoy line 402 from the cylinder 104.

For example, a galvanic timed release (GTR) link can be provided as a trigger mechanism 602, which breaks after a predetermined period of immersion, releasing the taut drawstring 116 and causing the drawstring 116 to go slack. This allows the top perimeter 110 or net top 106 to open and allows the buoy 404 and buoy line 402 to be released from the cylinder 104 and rise to the surface (See FIG. 5). In another example, an electronic timer or on-demand mechanical acoustic release can comprise a trigger mechanism 602 and trigger the release of the buoy 404 and buoy line 402 to the surface after a time duration as determined (e.g., set) by the user. Any desired delay time between a few hours and several days can be provided using various trigger mechanisms 602.

During the selected delay time, or prior to on-demand release, the retention device 102 or system 100 eliminates vertical buoy lines 402 and surface buoys 404 which are known to harm whales and other protected species. Once the buoy 404 has reached the surface, it can be retrieved by the fisher. Until the buoy 404 rises to the surface, the gear poses no threat to protected marine species from vertical line entanglement. The fishers are able to plan their trap set and recovery cycles around their selected release periods so that the trap recovery takes place as soon as possible after the emergence of the surface buoy 404.

Referring particularly to FIG. 6, for a retrofit embodiment, the completed retention device 102 can be installed onto a trap 604 (e.g., fish trap or shellfish trap, etc.) by securing the bottom perimeter 112 of the cylinder 104 (which can include a coupling support 114, comprising a plastic hoop, for example) to the trap 604 using metal clips, lashing twine or industrial wire ties, or other fasteners 606. The combination of the retention device 102 and the trap 604 comprises one embodiment of the system 100. Note that in some examples the cylinder 104 may be secured to the trap 604 without a coupling support 114, or with an alternate type of coupling technique.

The selected release mechanism 602 is installed and adjusted for the desired delayed release. The coiled buoy line 402 and the buoy 404 are placed inside the cylinder 104 and the drawstring 116 is pulled tight, so that when the drawstring is taut, the pucker of the top perimeter 110 causes downward pressure that holds the buoy line 402 and buoy 404 in place. This feature keeps the buoy 404 from emerging and the buoy line 402 from fouling prior to release. The drawstring 116 can be routed through a D-ring 608 for example, and a tensioner ring (not shown), if desired, and is coupled to the release mechanism 602.

Referring to FIGS. 7A-7G, in another embodiment of the system 100, the retention device 102 is used with a line retention container 702. In the embodiment, the completed retention device 102 is installed within the line retention container 702 to form the system 100 (see FIGS. 7C-7G). As illustrated at FIGS. 7A and 7B, in an embodiment, the line retention container 702 comprises a wire mesh basket or like container with an open top and holes or openings at least on the sides of the container 702. As shown at FIGS. 7A and 7B, in some embodiments, a cylinder 704 (a wire mesh cylinder, a solid cylinder with or without holes, etc.) can be nested within and may be coupled to the line retention container 702. The cylinder 704 can provide structural support to the line retention container 702 and can also provide structural support to the cylinder 104. The cylinder 704 can also guide the coiling action of the buoy line 402 as the buoy line 402 is inserted into the cylinder 104, and can help the coiled buoy line 402 keep the coiled form. In one example, the cylinder 704 comprises the cylinder 104 (see, for example, FIG. 7D).

Referring to FIGS. 7C and 7D, the cylinder 104 (e.g., the net mesh cylinder 104 at FIG. 7C, the wire mesh cylinder 104 at FIG. 7D, a solid cylinder 104 with or without holes, or the like) can be secured within the line retention container 702, and in some cases an additional wire basket 704. The coiled buoy line 402 and buoy 404 are placed inside the cylinder 104. The mesh cylinder 104 (if used) or a net top 106 (or other closure) is drawn closed with a drawstring 116 over the buoy line 402 and buoy 404 to hold them in the cylinder 104 in preparation for deployment. The drawstring 116 is pulled tight, so that when the drawstring is taut, the pucker of the top perimeter 110 causes downward pressure that holds the buoy line 402 and buoy 404 in place. This feature keeps the buoy 404 from emerging and the buoy line 402 from fouling prior to release. The drawstring 116 can be routed through a D-ring 608 for example, then a tensioner ring (not shown), if desired, and is coupled to the release mechanism 602. The selected buoy release trigger mechanism 602 is installed and adjusted. The triggering device 602 is used to keep the drawstring 116 taut until intentionally deployed.

In some cases, the system 100 is capable of adjustment for different amounts of buoy line 402. The coupling support 114, for example (or the bottom perimeter 112 of the mesh cylinder 104 in some cases) can be coupled to the rungs 706 (i.e., bottom rungs or side rungs) of the line retention container 702 (and/or the wire cylinder 704) and can be adjusted vertically (moved to higher or lower rungs 706) based on the user's desired quantity of buoy line 402 and/or the size of the buoy 404. For example, the line retention container 702 (and the wire cylinder 704) includes a plurality of coupling points (e.g., the various rungs 706) for height adjustment of the coupling support 114 (or the mesh cylinder 104) within the line retention container 702 and/or the wire cylinder 704.

Referring to FIGS. 7E and 7F, the bottom perimeter 112 of the cylinder 104 (or 704) or the coupling support 114, if used, is coupled to the line retention container 702 and/or the wire cylinder 704 via one or more of the plurality of coupling points (rungs 706), based on a desired height of the bottom perimeter 112 within the line retention container 702. The bottom perimeter 112 is attached to the wire mesh rungs 706 on the walls of the line retention container 702 (and/or the wire cylinder 704) using metal clips, lashing twine or industrial wire ties, or other fasteners 606. The cylinder 104 can be mounted to higher rungs 706 within the line retention container 702 (and/or the wire cylinder 704) to provide additional volume for more buoy line 402 (see FIG. 7F, for example), or mounted to lower rungs 706 within the line retention container 702 (and/or the wire cylinder 704) to provide less volume for a shorter buoy line 402 or smaller buoy 404 and to remove slack space (see FIG. 7E, for example). As the cylinder 104 (or the coupling support 114) is raised within the wire mesh of the line retention container 702 (and/or the wire cylinder 704), the line capacity changes. Adjustment of line capacity is important so that various amounts of buoy line 402 or different sized buoys 404 are always held tightly in place, so as to prevent fouling and tangles upon deployment and prior to triggered release.

FIG. 7G illustrates an embodiment wherein a different type of holding mechanism 720 is used to hold the buoy line 402 and buoy 404 in the cylinder 104 until deployment. The holding mechanism 720 can comprise an arm, a lever, a trap door, or a like device that can be put over or in the way of (e.g., block) the buoy 404 escaping from the cylinder 104. The holding mechanism 720 can be a hinged device or system, allowing the holding mechanism 720 to pivot open when triggered. Alternately, the holding mechanism 720 can be configured to remove completely from the cylinder 104 or the container 702 when triggered. In such an example, the holding mechanism 720 may be releasable, or biodegradable or otherwise capable of dissolving in sea water, for example. A triggering device 602 that releases the holding mechanism 720 can be used with this embodiment, as discussed above. The triggering device 602 can release one or more portions of the mechanism 720 from the system 100.

FIG. 8 shows an example of tethering one or more fish and/or shellfish traps 804 (or like devices) to the line retention container 702 and the retention device 102, or in other words, the system 100. Alternately, the string of traps 804 can be coupled to the system 100 comprising a retention device 102 coupled to a trap 604. This string of submerged traps 804 are often known as “groundlines” or “trawls,” and in combination with the system 100 comprises a trap system 802. The system 100 can be deployed and activated, with a desired delayed response. When triggered, the fisher can retrieve the combined trap system 802, based on the buoy 404 surfacing to indicate the location of the trap system 802.

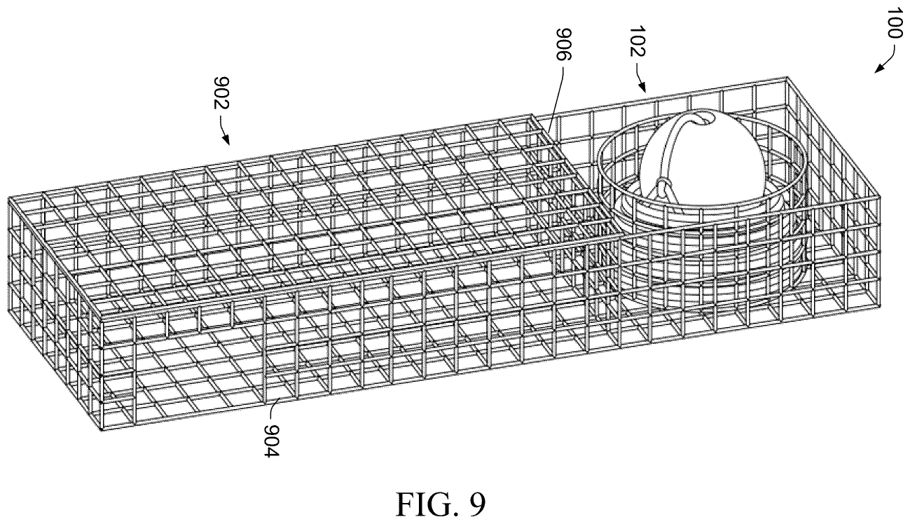

FIG. 9 shows an example of integrating the retention device 102 with a shellfish trap 902, such as a lobster trap, for example, to form a system 100. Integration of the retention device 102 (shown simplified for clarity) can include partitioning one portion of the shellfish trap 902 to separate it from the main body 904 of the shellfish trap 902. A partition 906 can divide the main body 904 from the retention device 102. The retention device 102 can occupy one end, one corner, or another partitioned portion of the shellfish trap 902 as desired.

In some cases, the cylinder 104 can be compressed into an oval shape to conserve space. The oval shaped cylinder 104 can help the overall length dimension of the system 100 to be shorter. In the examples, the oval shaped cylinder 104 allows the buoy line 402 to be coiled in like manner as discussed above, with the same advantages discussed herein.

The integrated shellfish trap 902 system 100 solves a number of problems. This system 100 can allow the retention device 102 to have the same height and width dimensions as the main body 904 to allow the system 100 to stack at the bottom of a gear pile properly.

The integrated retention device 102 means one less piece of gear to carry separately. Also, the fisherman can use a single sled for the integrated system 100, and does not need separate sleds for the shellfish trap 902 and the retention device 102. Saving space can be important on smaller boats that do not have room for extra devices that do not catch product.

The present disclosure uniquely provides an effective means of dependably eliminating persistent vertical lines and surface buoys. In addition, the system 100 has design features that make the objects of the disclosure economically viable for use in diverse fisheries. Since commercial fishing is a very dynamic and competitive endeavor, manipulation of traps prior to redeployment must be non-complex, reasonably quick and inexpensive. The present disclosure achieves all three of these requirements through its design and execution.

When a buoy 404 and buoy line 402 is retrieved, it is generally coiled in an orderly fashion mechanically or by hand. The cylinder 104 opens to allow the coil of buoy line 402 to be placed on top of the trap 604 or within the cylinder 104 or line retention container 702 with the buoy-end of the line 402 being on the top of the coil and the trap-end of the line 402 being on the bottom of the coil. The buoy 404 can then be placed at the center of the coil of line 402 prior to being secured in place by the drawstring 116. The drawstring 116 that holds the top perimeter 110 closed prior to deployment can be permanently secured to the cylinder 104 or another component. When the fisher secures the buoy line 402 and buoy 404 inside the cylinder 104, they pull the drawstring 116 to where it tightly holds the top perimeter 110 of the cylinder 104 by the selected trigger mechanism 602. The act of tightening the drawstring 116 is by design, simple and quick to accomplish. Once the retention device 102 is rigged, it can be deployed from a boat in the typical manner.

The size and dimensions of the retention device 102 and related components can vary based on the application. Regardless of the equipment size, the overall process is the same or similar. In various implementations, a system 100 or retention device 102 may include additional or alternate components, or have different shapes or sizes than those illustrated. Although various implementations and examples are discussed herein, further implementations and examples may be possible by combining the features and elements of individual implementations and examples.

### Representative Process

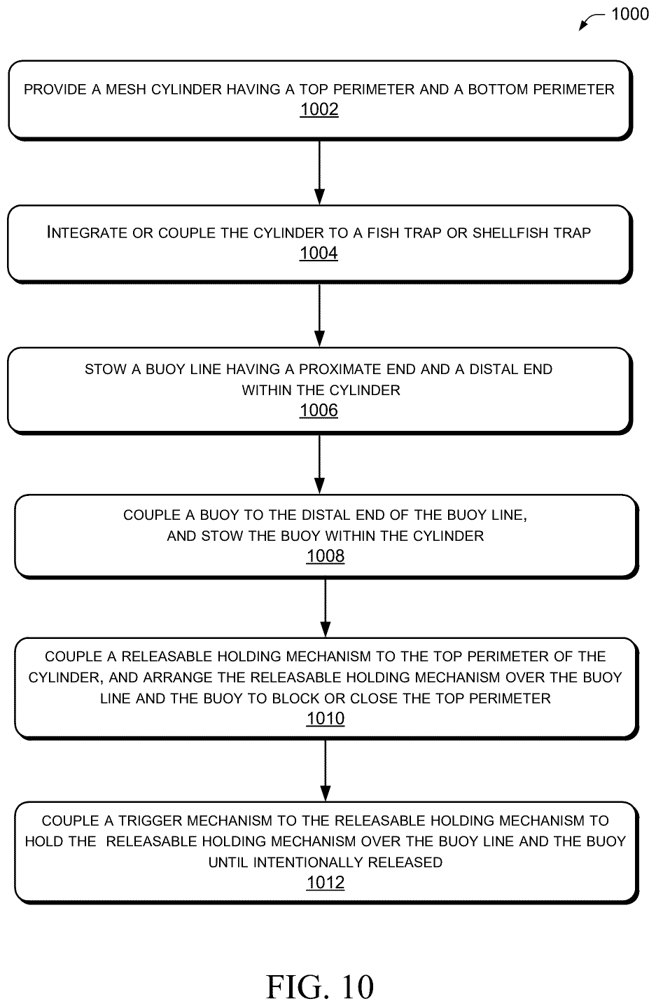

FIG. 10 illustrates a representative process 1000 for implementing techniques and/or devices relative to providing retention of a buoy line and buoy (such as the buoy line 402 and the buoy 404, for example), according to various embodiments. The process 1000 includes incorporating the retention device (e.g., retention device 102) with an existing fish or shellfish trap (such as the fish or shellfish trap 604, a shellfish trap 902, for example) or with a line retention container (such as the line retention container 702, for example). The example process 1000 is described with reference to FIGS. 1-9.

The order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented in any suitable hardware, software, firmware, or a combination thereof, without departing from the scope of the subject matter described herein.

At block 1002, the process includes providing a cylinder having a top perimeter and a bottom perimeter (such as the various embodiments of cylinders 104, for example). In various examples, the cylinder can comprise a wire mesh cylinder, a mesh netting cylinder, a cylinder with solid walls, a cylinder with solid walls having holes disposed therein, and the like. The cylinder can be elliptical or polygonal (or irregular) with a cylindrical form.

At block 1004, the process includes integrating or coupling the cylinder to a fishing apparatus (such as a fish or shellfish trap 604, a shellfish trap 902, or the line retention container 702, for example). In an example, the process includes optionally attaching a coupling support to the bottom perimeter of the cylinder and coupling the coupling support to the fishing apparatus. In one embodiment, the coupling support comprises a hoop, and includes threading the hoop through the bottom perimeter of the mesh cylinder. In another example, the fishing apparatus comprises a fish trap or a shellfish trap.

In a further example, the process includes coupling the bottom perimeter of the cylinder to a line retention container at one of a plurality of coupling points within the line retention container to determine a height of the bottom perimeter of the cylinder within the line retention container. In this way, the height of the cylinder within the line retention container can be adjusted. The adjustment can be useful for different lengths of buoy line, so that the buoy line and buoy remain snug within the cylinder, to prevent tangling or fouling of the buoy line.

At block 1006, the process includes stowing a buoy line having a proximal end and a distal end within the cylinder. At block 1008, the process includes coupling a buoy to the distal end of the buoy line, and stowing the buoy within the cylinder. In an example, the process includes coiling the buoy line within the cylinder and nesting the buoy on the coiled buoy line. The proximal end of the buoy line can be coupled to the line retention container or one or more fish traps, for example.

At block 1010, the process includes coupling a releasable holding mechanism to the top perimeter of the cylinder, and arranging the releasable holding mechanism over the buoy line and the buoy to block or close the top perimeter. In one example, the releasable holding mechanism comprises a net top coupled to the top perimeter of the cylinder. For instance, the net top can include a drawstring threaded through a portion of the net top, with the drawstring being taut in a first position to hold the top perimeter closed and being slack in a second position to allow the top perimeter to open. In the case of either a net top or a cylinder comprising netting, the process can include threading a drawstring through the top perimeter of the mesh netting, and pulling the drawstring taut to close the top perimeter over the buoy line and the buoy. This state describes the closed position or configuration.

In other examples, the releasable holding mechanism can comprise a trap door, a lever, or an arm (or the like) movably coupled or removably coupled to the top perimeter of the cylinder. The trap door, lever, arm, or other device can be positioned to block or to close the top perimeter of the cylinder in the closed position.

At block 1012, the process includes coupling a trigger mechanism to the releasable holding mechanism to hold the releasable holding mechanism over the buoy line and the buoy until intentionally released. The process further includes activating the trigger mechanism to open or unblock the top perimeter of the cylinder and intentionally release the buoy line and the buoy. This can be performed remotely or automatically via a variety of trigger mechanisms. Once triggered, the holding mechanism releases or is removed, which allows the buoy and the buoy line to escape from the cylinder in response to the opening of the top perimeter of the cylinder. In various examples, the buoy is allowed to surface, where it can be seen by the user. The user may retrieve the buoy, the buoy line, and any fishing apparatus attached thereto.

In an implementation, the process includes coupling the fishing apparatus to one or more fish traps or shellfish traps. For example, the fishing apparatus and one or more fish traps or shellfish traps can comprise a tethered trap system.

In alternate implementations, other techniques may be included in the process in various combinations, and remain within the scope of the disclosure.

Aspects of the present disclosure have been described with the intent to be illustrative rather than restrictive. Alternative aspects will become apparent to those skilled in the art that do not depart from its scope. A skilled artisan may develop alternative means of implementing the aforementioned improvements without departing from the scope of the present disclosure.

It will be understood that certain features and sub-combinations are of utility and may be employed without reference to other features and sub-combinations and are contemplated within the scope of the claims. Not all steps listed in the various figures need be carried out in the specific order described.

### CONCLUSION

Although the implementations of the disclosure have been described in language specific to structural features and/or methodological acts, it is to be understood that the implementations are not necessarily limited to the specific features or acts described. Rather, the specific features and acts are disclosed as representative forms of implementing the claims.

I claim:

1. A buoy retention and release device for a fishing apparatus, comprising:
a cylinder having a top perimeter and a bottom perimeter, the top perimeter being blocked or closed in a first position and being open in a second position;
a holding mechanism disposed at the top perimeter of the cylinder, the holding mechanism blocking or closing the top perimeter of the cylinder in the first position and unblocking or opening the top perimeter of the cylinder in the second position;
a buoy line having a proximate end and a distal end, the buoy line being stowed within the cylinder in the first position and being free to extend out from the cylinder in the second position;
a buoy attached to the distal end of the buoy line, the buoy being held within the cylinder in the first position and being released from the cylinder in the second position; and
a trigger mechanism coupled to the holding mechanism, the trigger mechanism configured to hold the holding mechanism in the first position until automatically or remotely triggered and to activate the second position when triggered.

2. The buoy retention and release device of claim 1, further comprising a line retention container, the line retention container comprising an open-top basket configured to hold the cylinder.

3. The buoy retention and release device of claim 2, wherein the line retention container includes a plurality of coupling points for adjusting a height of the cylinder within the line retention container.

4. The buoy retention and release device of claim 1, wherein the holding mechanism comprises a net top coupled to the top perimeter of the cylinder, the net top including a drawstring threaded through a portion of the net top, the drawstring being taut in the first position to hold the top perimeter closed and being slack in the second position to allow the top perimeter to open.

5. The buoy retention and release device of claim 1, wherein the holding mechanism comprises a trap door, a lever, or an arm movably coupled or removably coupled to the top perimeter of the cylinder.

6. The buoy retention and release device of claim 1, wherein the cylinder is integral to or coupled to the fishing apparatus, and wherein the fishing apparatus comprises a fish trap or a shellfish trap.

7. The buoy retention and release device of claim 1, wherein the cylinder is comprised of wire mesh or of mesh netting.

8. The buoy retention and release device of claim 1, wherein the cylinder is comprised of solid walls or solid walls with a plurality of holes disposed therein.

9. A buoy retention and release device for a fishing apparatus, comprising:
a cylinder integral with or coupled to the fishing apparatus, the cylinder having a top perimeter and a bottom perimeter, the top perimeter being blocked or closed in a first position and being open in a second position;
a holding mechanism disposed at the top perimeter of the cylinder, the holding mechanism blocking or closing the top perimeter of the cylinder in the first position and unblocking or opening the top perimeter of the cylinder in the second position;
a buoy line having a proximate end and a distal end, the buoy line being stowed in a coil within the cylinder in the first position and being free to extend out from the cylinder in the second position;
a buoy attached to the distal end of the buoy line, the buoy being held within the cylinder in the first position and being released from the cylinder in the second position; and
a trigger mechanism coupled to the holding mechanism, the trigger mechanism configured to hold the holding mechanism in the first position until triggered and to activate the second position when triggered.

10. The buoy retention and release device of claim 9, wherein the buoy is nested on the coiled buoy line in the first position.

11. The buoy retention and release device of claim 9, wherein the trigger mechanism comprises a galvanic link configured to corrode in seawater or a mechanical release device.

12. The buoy retention and release device of claim 9, wherein the trigger mechanism comprises an electronic and/or acoustic remote release device.

13. A method, comprising:
providing a cylinder having a top perimeter and a bottom perimeter;
integrating or coupling the cylinder to a fish trap or shellfish trap;
stowing a buoy line having a proximate end and a distal end within the cylinder;
coupling a buoy to the distal end of the buoy line, and stowing the buoy within the cylinder;
coupling a releasable holding mechanism to the top perimeter of the cylinder, and arranging the releasable holding mechanism over the buoy line and the buoy to block or close the top perimeter; and
coupling a trigger mechanism to the releasable holding mechanism to hold the releasable holding mechanism over the buoy line and the buoy until intentionally released.

14. The method of claim 13, further comprising coupling the bottom perimeter of the cylinder to a line retention container at one of a plurality of coupling points within the line retention container to determine a height of the bottom perimeter of the cylinder within the line retention container.

15. The method of claim 13, further comprising coiling the buoy line within the cylinder and nesting the buoy on the coiled buoy line.

16. The method of claim 13, further comprising activating the trigger mechanism to open or unblock the top perimeter of the cylinder and intentionally release the buoy line and the buoy.

17. The method of claim 13, wherein the releasable holding mechanism comprises a net top coupled to the top perimeter of the cylinder, the net top including a drawstring threaded through a portion of the net top, the drawstring being taut in a first position to hold the top perimeter closed and being slack in a second position to allow the top perimeter to open.

18. The method of claim 13, wherein the releasable holding mechanism comprises a trap door, a lever, or an arm movably coupled or removably coupled to the top perimeter of the cylinder.

19. The method of claim 13, wherein the cylinder is comprised of mesh netting or of wire mesh.

20. The method of claim 13, wherein the cylinder is comprised of solid walls or solid walls with a plurality of holes disposed therein.
